(19) United States
(12) Patent Application Publication
(10) Pub. No.: US 2010/0039561 A1
(43) Pub. Date: Feb. 18, 2010

(54) SYSTEM, METHOD, COMPUTER-READABLE MEDIUM, AND USER INTERFACE FOR DISPLAYING LIGHT RADIATION

(75) Inventor: Cornelis Wilhelmus Kwisthout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,527

(22) PCT Filed: Dec. 14, 2007
(86) PCT No.: PCT/IB07/55110

§ 371 Date: Jun. 17, 2009

(30) Foreign Application Priority Data
Dec. 21, 2006 (EP) 06126931.2

(51) Int. Cl. H04N 9/04; H04N 5/222; H04N 9/31; H04N 5/74

(52) U.S. Cl. 348/576; 348/E05.022; 348/E09.002; 348/699; 348/744; 348/E09.025; 348/E05.137

(57) ABSTRACT

A system that provides a more immersive viewing experience of an image sequence is provided. This is realized by extending the currently presented frame of the image sequence. The backlighting effect is used to display the extended part of the currently presented frame. A method and computer-readable medium is also provided.

### FIELD OF THE INVENTION

This invention pertains in general to a visual display system suitable for including with or adding to display devices, such as television sets. Moreover, the invention relates to a method, computer-readable medium, and graphical user interface for operating such visual display system.

### BACKGROUND OF THE INVENTION

Visual display devices are well known and include cinematic film projectors, television sets, monitors, plasma displays, liquid crystal display LCD televisions, monitors, and projectors etc. Such devices are often employed to present images or image sequences to viewer.

The field of backlighting began in the 1960s due to the fact that televisions require a “darker” room for optimal viewing. Backlighting is in its simplest form white light, emitted from e.g. a light bulb, projected on a surface behind the visual display device. Backlighting has been suggested to be used to relax the iris and reduce eye strain.

During recent years the backlighting technology has become more sophisticated and there are several display devices on the market with integrated backlighting features that enables emitting colors with different brightness depending on the visual information presented on the display device.

The benefits of backlighting in general includes: a deeper and more immersive viewing experience, improved color, contrast and detail for best picture quality, and reduced eye strain for more relaxed viewing. Different advantages of backlighting require different settings of the backlighting system. Reduced eye strain may require slow changing colors and a more or less fixed brightness while more immersive viewing experience may require an extension of the screen content i.e. the same brightness changes with the same speed as the screen content.

A problem with current backlighting systems is to really extend the image content of the presented image sequence for more immersive viewing experience.

Hence, an improved system, method, computer-readable medium, user interface would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a system, a method, and a computer-readable medium according to the appended patent claims.

According to one aspect of the invention, a system is provided. The system comprises an adaptation unit configured to adapt a first image frame of an image sequence based on correlation between motion vectors of the first frame, and motion vectors of a second frame of the image sequence. Moreover the system comprises a reconstruction unit configured to reconstruct an extended image for the second frame by image stitching the adapted frame to the second frame. Furthermore, the system comprises a monitor unit configured to monitor image information in at least one monitoring region comprised in the extended image, and to generate a first signal, and a control unit configured to control light radiation emitted in use from an illumination area connected to the monitoring region in response to the first signal.

According to another aspect of the invention a method is provided. The method comprises adapting a first image frame of an image sequence based on correlation between motion vectors of the first frame, and motion vectors of a second frame of the image sequence. Moreover, the method comprises reconstructing an extended image for the second frame by image stitching the adapted frame to the second frame. Furthermore, the method comprises monitoring image information in at least one monitoring region comprised in the extended image, and generating a first signal, and controlling light radiation emitted in use from an illumination area connected to the monitoring region in response to the first signal.

According to yet another aspect of the invention a computer-readable medium having embodied thereon a computer program for processing by a processor is provided. The computer program comprises an adaptation code segment configured to adapt a first image frame of an image sequence based on correlation between motion vectors of the first frame, and motion vectors of a second frame of the image sequence. Moreover, the computer program comprises a reconstruction code segment configured to reconstruct an extended image for the second frame by stitching the adapted frame to the second frame. Furthermore, the computer program comprises a monitor code segment configured to monitor image information in at least one monitoring region comprised in the extended image, and to generate a first signal, and a control code segment configured to control light radiation emitted in use from an illumination area connected to the monitoring region in response to the first signal.

According to yet another aspect of the invention a user interface for use in conjunction with the system according to any of the claims 1 to 9 is provided. The graphical user interface is configured to control user-defined or predetermined settings correlated to the monitoring region and/or motion vectors.

Some embodiments of the present invention propose display system comprising units configured to generate an extended image content from the current image frame of the image content that is displayed, e.g. on a display device. This extended image content may subsequently be used to derive the backlighting effect. In this way the backlighting effect is not merely a repetition of the image content of the currently presented frame anymore, but a real extension. This also makes the backlighting effect truly motion adaptive.

In some embodiments of the present invention backlighting illumination areas, comprised in the display system are used to display the extended part of the image content while the display system still displays the current frame as normal. Extending the image content basically means that the standard image content displayed by the display system continues on the backlighting illumination areas.

In some embodiments the units utilize algorithms comprising stitching techniques to stitch at least two subsequent frames together to create the extended image.

In some embodiments the provided system, method, and computer-readable medium allow for increased performance, flexibility, cost effectiveness, and deeper and more immersive viewing experience.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a block diagram of a system according to an embodiment;

FIG. 2 is a schematic illustration of a system according to an embodiment;

FIG. 3 is a schematic illustration of a system according to an embodiment;

FIG. 4 is a schematic illustration of a system according to an embodiment;

FIG. 5 is a block diagram of a method according to an embodiment; and

FIG. 6 is a block diagram of a computer-readable medium according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on embodiments of the present invention applicable to backlighting of visual display devices, such as cinematic film projectors, television sets, monitors, plasma displays, liquid crystal display LCD televisions, projectors etc. However, it will be appreciated that the invention is not limited to this application but may be applied to many other areas in which backlighting is desired.

The present invention according to some embodiments provides a more immersive viewing experience. This is realized by extending the presented image content on the display device using backlighting. The backlighting effect is used to display the extended part of the content while the display device still displays the image content.

By extending the display device with a backlighting effect the consumer gets the impression the display device is larger than it is, which resembles the same experience as in a cinema with large cine screen. Extending the display device basically means that the image content displayed on the screen, continues on the backlighting display system. However, this extended image content is not available since it is not comprised in the video signal that enters the display device.

Moreover, the present invention provides a way to correlate the extended image content to illumination areas of the display system, and thus presenting the extended image to the user. The present invention according to some embodiments is based upon the possibility to stitch images. Image Stitching is a commonly known part within the field of Image Analysis, in which several images may be attached to one another. An effect achieved with image stitching is e.g. that it is possible to create a large panoramic image of several smaller images of the panoramic view. Most commercially available digital cameras have this feature and the stitching effect is controlled by software.

Stitching algorithms are also known in the field of Video Processing. By creating a motion vector field of succeeding frames of the image content, the camera action, e.g. panning, zooming and rolling may be calculated. Some algorithms may generate a real 3D world out of the information. Others focus on 2D camera actions only.

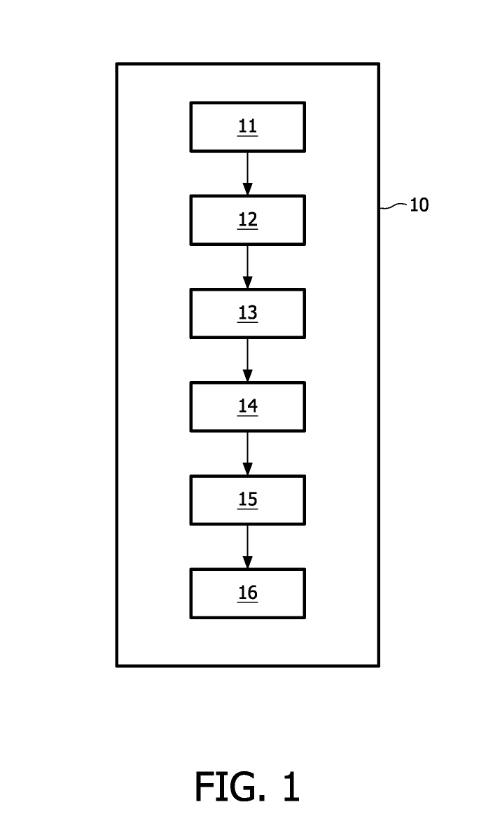

In an embodiment, a display system 10, according to FIG. 1, is provided. The system is used in conjunction with a display device comprising a display region capable of presenting a current frame of an image sequence to a viewer. The system comprises

a motion calculation unit 11 for calculating motion vectors of at least two subsequent frames of the image sequence,

an adaptation unit 12 for adapting a previous frame of the image sequence based on the motion vectors in such way that it matches the camera parameters of the current frame,

a reconstruction unit 13 for reconstructing an extended image for the current frame by stitching the adapted frame to the current frame,

a monitor unit 14 for monitoring at least the intensity and color in one or more monitoring regions of the extended image, and generating a first signal, wherein the size and position of each monitoring region depends on the motion vectors, and

a control unit 15 for controlling light radiation emitted in use from an illumination area 13 in response to the first signal and the position of each illumination area 13 within the system.

The extended image is continuously altered by including parts of the previous frame combined with the current frame. Accordingly, the extended image may grow with each new frame that is encountered, based on the motion compared to the previous extended image referring to the previous frame. Only when there is reason to believe that the current new frame has no correlation with the previous extended image, e.g. after a scene change, the previous extended image is reset, i.e. deleted and the processing loop starts all over again. A stitched result that continues growing also facilitates in the following case: when the camera first makes a pan to the right and then to the left. In this case first the scene extends at the left (pan to the right) and then when the camera goes back the extension is kept at the left side until the camera goes over the original starting point (because left from this part of the scene there is no available information yet) while the extension is still at the right side.

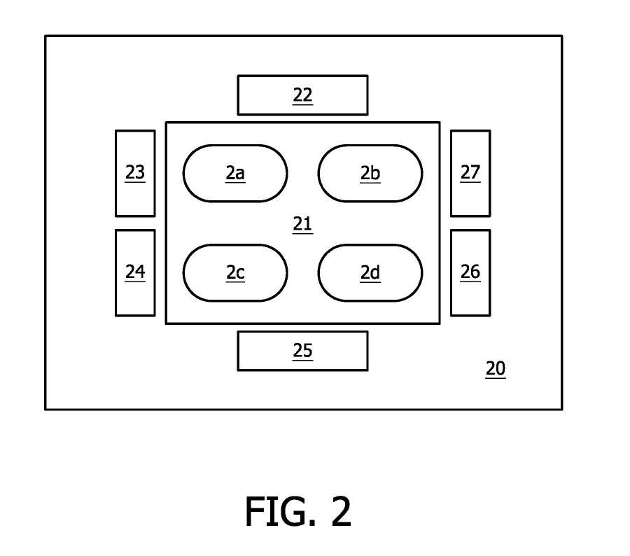

FIG. 2 illustrates a display system according to an embodiment of the invention. As may be observed in FIG. 2 the display region 21 is divided into several monitoring regions, each monitoring region being connected to at least one illumination area. FIG. 2 illustrates a display system 20 comprising four monitoring regions 2a, 2b, 2c, and 2d and six illumination areas 22, 23, 24, 25, 26, 27. Each illumination area is via a control unit and monitor unit, such as an electric drive circuit, connected to at least one monitoring region according to the following Table 1.

TABLE 1

| Illumination | Monitoring |
|---|---|
| area | region |
| 22 | 2a and 2b |
| 23 | 2a |
| 24 | 2c |
| 25 | 2c and 2d |
| 26 | 2d |
| 27 | 2b |

As may be observed in Table 1, illumination area 22 is connected to the combined color information of monitoring region 2a and 2b. Similarly, illumination area 25 is connected to the combined color information of monitoring segment 2c and 2d. The illumination areas 23, 24, 26, and 27 correspond to monitoring regions 2a, 2c, 2d, and, 2b, respectively.

### Motion Calculation Unit

Motion vectors define the direction and the ‘power’ of the object it belongs to. In case of motion the power defines the ‘speed’. The dimension of the motion vector depends on the dimension of the application, in 2D applications the motion vector is a 2D vector, and in 3D applications it is consequently a 3D vector. Generally, to create a motion vector the frame is divided by a certain grid into several macro-blocks. Using state-of-the-art techniques from every macro-block the motion vector is derived in what direction it is moving and how fast. This information may be used to predict where the macro-block would be in the future or in unavailable information, e.g. when 24 Hz film material is converted to 50 Hz material where each frame is different. Since the content within a certain macro-block may be different real objects with different motion vectors, this macro-block motion vector could be interpreted as the average motion occurring inside a block. Ideally one would want to have a motion vector for each content pixel but this however requires very high computation capacity. Macro-blocks that are very large, also results in errors since they may contain too much information of different objects in the content.

One way of extracting actions, such as motions from image content, is by comparing different frames and doing so, generating a motion vector field indicating the direction and speed with which pixels move. In practice macro blocks consist of several pixels and lines, e.g. 128×128, because pixel based processing would require too much computational capacity. Such a motion vector field may then be used to identify where motion is present.

In an embodiment the motion vectors calculated by the motion calculation unit describe the camera action in terms of the camera parameters panning, zooming and/or rolling.

In an embodiment the motion calculation unit 11 generates a motion vector signal which is fed to the monitor unit 14, which subsequently may lead to changed monitoring region position, size and/or shape of the extended image by use of the control unit. In this embodiment the motion vector signal is incorporated in the first signal.

In an embodiment the motion calculation unit forwards the motion vector signal directly to the control unit 15, which subsequently may lead to change of reaction times for an illumination area.

The motion or action triggering the change of the monitoring region position, size and/or shape may be measured as a threshold value based on an motion vector signal corresponding to the action in the display region. If the motion vector signal is below the threshold value the monitoring regions are not changed. However, when the motion vector signal is above the threshold value the monitoring regions may be changed.

### Adaptation Unit

In an embodiment the adaptation unit is configured to adapt a previous frame based on the calculated motion vectors such that it matches the camera parameters of the current frame. One way of doing this is to take into account the motion vectors for the current frame and compare these with motion vectors of a previous frame and extract global motion vectors defining the camera action. By comparing a resulting motion vector ‘picture’ comprising all motion vectors for the current frame with previous motion vector ‘pictures’, previously calculated using previous frames the camera action, and hence camera parameters may be derived. This is possible as either the objects that is captured by the camera is still or moving or the camera is still or moving, or a combination of both. The difference of the current frame with the previous frame may then be calculated, e.g. for a camera panning to the right the camera speed may be 100 pixels to the right per frame. This information is then used to adapt, i.e. transform, the previous frame such that it matches the current frame. For the mentioned example of camera speed of 100 pixels to the right, the adapted frame will comprise the left 100 pixels of the previous frame.

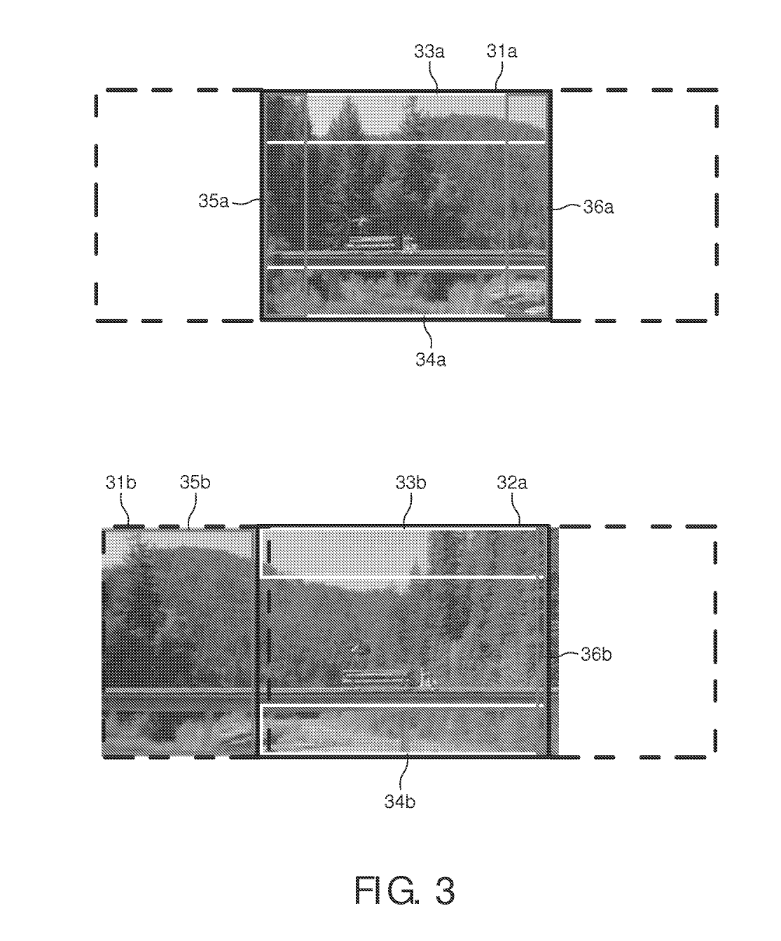

FIG. 3 shows the functionality of the system according to some embodiments with reference to an image sequence made by a camera tracking a truck and a helicopter on a bridge. For example, for each frame the motion vectors from the macro-blocks that contain the truck and the helicopter, will be more or less motionless while all other macro-blocks have a motion vector directed to the left with the same power and also with the same power and direction in time over multiple frames. From this it may be derived that either the camera is fixed on a fixed object and some very large objects is moving towards the left with a very high speed, or the camera is panning very quickly to the right with about the same speed as the truck and helicopter. As the largest part of the exemplified scene is moving it may be decided that there is a camera pan to the right with a certain speed. From this speed it may be derived how many pixels each new frame is shifted to the right or, more importantly, how many pixels to the left of the currently presented image the previous image should be positioned, in order to create an extended image.

### Reconstruction Unit

After adapting a previous frame the reconstruction unit is configured to stitch the current frame together with the previous frame.

For example, in case of a camera zoom in to an object in the middle of the screen, the adapted frame is derived from the motion vector pictures, and all motion vectors point outwards from the center of the screen. Basically this translates into the fact the each new frame is part of the previous frame that is scaled up to the full screen size. Hence, in order to stitch the previous frame to the current frame, that previous frames also needs to be zoomed, scaled, before it may be positioned behind the current frame.

In an embodiment the adaptation of previous frames and reconstruction of the extended image is performed using commonly known state of the art algorithms. Some image errors may occur using these algorithms, however, as backlighting effects are not high detailed the errors will not be visible to the user. Accordingly when motions occur in a presented image sequence, the user will always see the current frame in the display region. However when motions occurs, such as a fast camera panning to the right, the extended image constructed by the reconstruction unit makes it possible to generate the backlighting effect by the illumination areas at the left side of display region from the extended image. Hence, the extended image only influences the backlight created by the illumination areas and no the current frame.

### Monitoring Region

If a monitoring region contains predominantly green colors at a point in time, the first signal from the monitor unit will comprise information to emit a green color and so forth. The monitor unit that via the control unit is connected to the illumination areas is responsive to color and brightness information presented in the monitoring regions and produce signals for the illumination areas, which are fed into the control unit for controlling the color and brightness of each illumination area in the display system.

Other algorithms picking the dominant color in a monitoring region and converting the color into a first signal may also be used. As an example, an averaging algorithm averaging all colors in the monitoring region may be used.

In an embodiment each monitoring region size is dependent on the calculated motion vectors, describing the camera action, from the presented image sequence. As an example the width of a monitoring region may be dependent on horizontal movement and the height may be dependent on vertical movement of the camera. In other words, fast camera movements result in small monitoring regions, making the repetition less visible while slow motion or no motion, results in wider monitoring regions.

In an embodiment other camera motion may also be translated into an adapted width of the monitoring region. In fact all camera action may be translated into an adapted width if there is not stitched information present. For example, when a scene starts and the camera then zooms out, it is not possible to create an extended image as the new frame covers a bigger part of the scene than the previous one. However, the motion vectors in the monitoring regions will all point inwards towards the center focus point of the camera. In this case the size of the monitoring regions may still be adapted as the size parameter is parallel dependent on the motion vectors. The sizes of the monitoring regions will become smaller in this case.

As an example, in case there would be a fast pan to the right, the motion vectors would point to the left and therefore the width of the monitoring region at the right side of the display region would be small because there is no stitched image content available at the right side of this monitoring region as it is not yet broadcasted and combined with the motion vector information this results in narrowing the width of this area to keep the correlation high. In the zoom out case the motion vectors of this particular monitoring region, still located at the right side of the display region, also point to the left and again there is no previously stitched information outside the area available and accordingly the width is made smaller. Thus any camera action may be translated into an adaptation of the size of a monitoring region according to this embodiment.

In an embodiment, if the calculated motion vector values are higher than a predetermined vector value threshold the monitoring region size, shape and/or position may be altered using the monitor unit.

FIG. 3a describes a first frame 31a of the image sequence. As the background pans very fast to the left, i.e. the camera pans very fast to the right, the calculated motion vectors will have direction to the left. FIG. 3a moreover illustrates four monitoring regions 33a, 34a, 35a, and 36a. The sizes and positions of the monitoring regions are shown in an exemplary default setting. This means that the if no motion is detected in the image sequence, these default monitoring regions are used to create the first signal that is subsequently processed by the control unit for controlling color and brightness of illumination areas connected to these illumination areas. FIG. 3b illustrates a subsequent frame 32a. The calculation of motion vectors, i.e. camera motion, is used to extend the scene at the left side of the frame, indicated by 32a in FIG. 3b, using the adapted previous frame 31b and the reconstruction unit 13 to create an extended image 30.

In an embodiment the extended image will comprise the image content of the current frame together with extended image information originating from previous frames. The size of the extended image will depend on the amount of camera action, e.g. fast panning results in a larger image than slow panning, and on the number of (previous) frames being used in the adapting step.

As motion is detected, the monitoring region size and position is changed from the default setting to e.g. the corresponding monitoring region settings indicated by 33b, 34b, 35b, and 36b. In an embodiment this means that illumination areas located to the left and right of the display region of the display device will emit color and brightness depending on monitoring region 35b and 36b, respectively. Illumination areas located above and below the display region of the display device will emit color and brightness depending on monitoring region 33b and 34b, respectively. By using this stitched scenery as the basis for the left side backlighting, the trees that were in the earlier scenes move from the display region to the illumination areas on the left side of the display region. At the right side of the display region there is also motion information, however since the motion vectors pointing in the other direction, it is not possible to stitch previous frames to the right side of the current frame in order to create additional content, as the motion vectors are directed to the left, as the camera tracks the truck going to the right, and hence no previous frames gives image information for this side of the display region. In the resulting frames the truck stands more or less motionless in the middle of the frame. From the truck's point of view the background moves to the left since the truck from the background's point of view moves to the right, and therefore the background motion vectors are directed to the left. This means that the background of the previous frames may be used to extend the background of the current frame at the left side of that frame. As a consequence of the camera motion the right monitoring region width may be narrowed down, using the monitor unit 14 making small details have a big impact on the right side backlighting. This results in a turbulent backlighting effect at the right side, just like when the user would actually see the trees flashing by. As there is no vertical movement in the presented image sequence, the monitoring regions 33a and 34a connected to the illumination areas located above and below the display region remains unchanged, i.e. monitoring regions 33a and 34a are equal to monitoring regions 33b and 34b, respectively, during the presented image sequence.

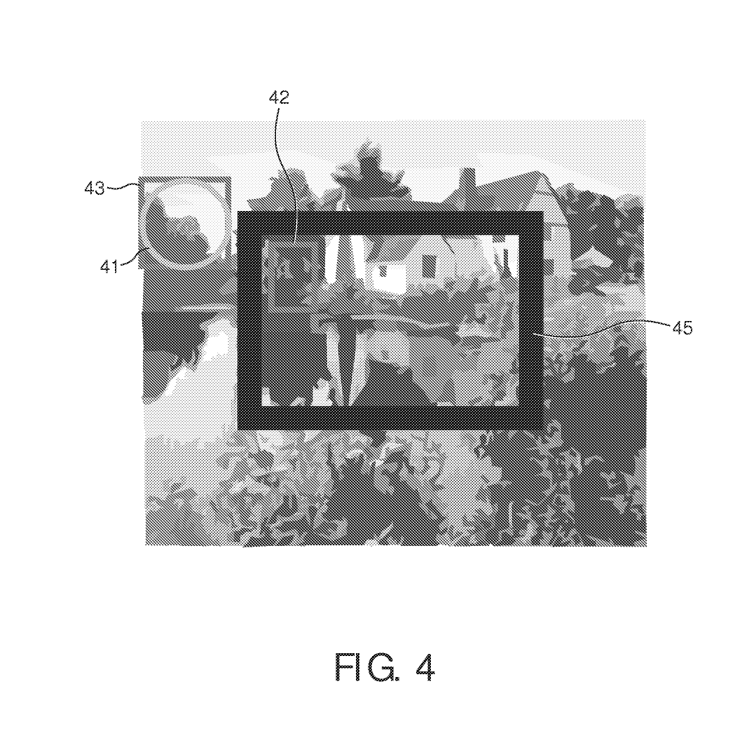

The present invention according to some embodiments provides a way of extending the image content outside the screen by stitching previous frames to the current frame. In this way, with reference to FIG. 4, it is possible to move the monitoring region from a default position 42 towards an ideal position 43. For practical reasons the size of monitoring region at position 42 could be different than the size of monitoring region at position 43. This may have nothing to do with any movement of the camera and may be merely dependent on the fact that the size of the illumination area may be different than the size of the default monitoring region at position 42. In an extreme example, suppose the illumination area size has a diagonal of 1 m, but there is not 1 m diagonal content available on e.g. a 32 inch TV set. When moving the monitoring region from its default position 42 towards it ideal position 43 the size may be morphed from the default size to the ideal size. Thus, the camera action has nothing to do with this adjustment other than it allows the stitching and creation of the extended image. In this example, according to FIG. 4, when the stitched image content would only be half of the shown content, the monitoring region would be halfway between position 42 and 43 and it would have a size that is the average of the size of monitoring region at position 42 and the size of monitoring region at position 43.

As motion information, i.e. camera action, is available according to some embodiments, this information may be used to change the size of the monitoring region according to embodiments above. Normally this adjustment of the size is only required when the monitoring region is located inside the display region because there is no stitched information available. However, in the case as illustrated in FIG. 4, if the camera moves towards the left, i.e. that the display region shifts to the left, the monitoring region moves together with the display region, so the left side of this monitoring region spot does not have any virtual content underneath it. Hence, two options are available, either the width of the monitoring region 43 may be decreased from the left side but keep the relative position of this monitoring region as long as possible next to the display region, or the size and position of the monitoring region may be changed towards the default position.

In an embodiment the first option relating to keep the position as long as possible on the ideal position and initially only vary the size and subsequently, as the camera moves and no extended image information is available in the monitoring region, then start changing the size and/or position towards the default size and/or position, could be regarded as a non-linear transition. The latter option relating to changing the size and/or position towards the default size/position could be regarded as a linear transformation between the default and ideal position. Accordingly, the change from ideal to default mode may be a linear transition and non-linear. This capability provides for various ways of controlling the position and size of the monitoring regions of the system.

In an embodiment, dependent on different situations in terms of camera action etc, there are ideal positions and sizes of the monitoring regions and that the monitoring region may have default sizes and positions. In practice the monitoring region linked to a certain illumination area will vary between the two parameters depending on the situation. Furthermore, in the default situation the size, i.e. width and height, of the monitoring region may be adapted according to the camera action and when there is not yet any stitched content available at that side.

In an embodiment, ideally the monitoring region is located where the illumination area is. So, if the illumination area is top-left with respect to the physical TV, the monitoring region should be located at the same spot in case the image would be virtually extended over the wall. While no motion is detected, i.e. default mode, and no extended image is available, all monitoring regions are located with the display region. If motion is detected and an extended image is created the monitoring position, may be moved towards the top-left position. If no motion is detected between two or more subsequent frames, but an extended image is available from earlier previous frames, the monitoring region position may remain the same as before. FIG. 4 illustrates a display region 45 showing a default position 42 of a monitoring region connected to an illumination area 41 located on the top-left of the display region. An ideal position 43, requiring a large extended image and thus much movement in the image sequence, of the monitoring region is also showed. If the image content is only slightly extended, the monitoring region would have a position somewhere in between position 42 and 43. Like mentioned above, this exact position could be derived in a linear way and in a non-linear way.

In an embodiment a method for controlling the size and/or position of a monitoring region is provided. The control unit or monitor unit of the system may utilize the method. In step 1) the camera action is derived, e.g. as mentioned above. In step 2a) if there is no camera action the size and position of the monitoring region will be the same as for the previous frame settings, thus if there was stitched content, the same settings are used as before and otherwise the default monitoring region parameters are used. In step 2b) if there is camera action the monitoring region is changed, if not already in this state, to the position and size of the ideal situation, wherein the monitoring region is located on the same spot as the illumination area to which it is connected. Where possible this changing may be linear or non-linear and when it is not possible, e.g. because the action is in such way that there is no stitched image information at the position of the monitoring region, the size parallel to the camera motion vectors is changed accordingly to the default position.

In an embodiment the size of each monitoring region is also adapted to the availability of extended image content. In some embodiments the monitoring region is a box with the size of the illuminated area positioned at the illuminated area. In some embodiments the default size is a small box located inside the display region.

### Control Unit

The control unit is capable of controlling the light radiation of the illumination areas of the display system. It continuously receives signals from the monitor unit regarding the color and brightness of each illumination area and may use this information together with other criteria in order to control the light radiation color and brightness of the illumination areas.

In an embodiment the control unit further controls the monitoring region depending on image or image sequence content presented in the display region. This means that the monitoring regions are variables depending on both the image or image sequence content and their individual position within the extended image and/or display system.

In an embodiment the control unit is capable of integrating the received signal from the monitor unit for the affected illumination areas over time, corresponding to color summation over a number of frames of the presented image content. Longer integration time corresponds to increased number of frames. This provides the advantage of smooth changing colors of illumination areas with long integration time and rapid color changes of illumination areas with short integration time.

Display system setups other than those described above are equally possible and are obvious to a skilled person and fall under the scope of the invention, such as setups comprising a different number of monitoring regions, monitoring region locations, sizes and shapes, number of illumination areas, different reaction times etc.

### Scene Change Detector

In an embodiment the display system further comprises utilizing a scene change detector to reset the current extended image and start over. After resetting the extended image the extended image exclusively comprises the currently presented frame, and thus any adapted frame is removed. Accordingly, if a scene change is detected, the previous frame (extended or not) may obviously not be transformed in any way to match the new frame (first frame of the new scene). Therefore, the stitching algorithm is reset and starts with this new frame to try to extend again the whole scene from this frame onwards. If a scene change is detected, this means that the monitoring regions will be set to default position, shape and/or size, e.g. within the display region 21 as indicated in FIG. 2 and FIG. 4.

An advantage of the display system according to the above-described embodiments is that both motion and background continuation is taken into account without disturbing the display region 21 viewing experience. As the human eye provides most resolution in the central part of the field of view and poorer resolution further away from the central part of the field of view, the viewer will have increased experience of the actions, such as motions, happening on the display region.

The motion calculation unit, adaptation unit, reconstruction unit, monitor unit and control unit may comprise one or several processors with or several memories. The processor may be any of variety of processors, such as Intel or AMD processors, CPUs, microprocessors, Programmable Intelligent Computer (PIC) microcontrollers, Digital Signal Processors (DSP), Electrically Programmable Logic Devices (EPLD) etc. However, the scope of the invention is not limited to these specific processors. The processor may run a computer program comprising code segments for performing image analysis of the image content in the display region in order to produce an input signal dependent on the color and brightness of the image content that is fed to an illumination area. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

In an embodiment the monitor unit and the control unit is comprised in one unit.

In some embodiments several monitor units and control units may be comprised in the display system.

The display system according to some embodiments may comprise display devices having display regions such as TVs, flat TVs, cathode ray tubes CRTs, liquid crystal displays LCDs, plasma discharge displays, projection displays, thin-film printed optically-active polymer display or a display using functionally equivalent display technology.

In an embodiment the display system is positioned substantially behind the image display region and arranged to project light radiation towards a surface disposed behind the display region. In use the display system provides illumination of at least at part around the display region of a display device.

In use the display system works as a spatially extension of the display region that increases viewing experience. The illumination areas utilize different monitoring regions depending on motions occurring in the presented image sequence.

### Illumination Area

In an embodiment the illumination area comprises at least one source of illumination and one input for receiving a signal, e.g. from the monitor unit, that controls the brightness and or color of the illumination source.

There are several ways of how to create the illumination area input signals, using which algorithms etc. In a simple example the algorithm just repeats the average or peak color of a certain monitoring area to its corresponding illumination area, however several algorithms are known in this regard and may be utilized by the display system according to some embodiment of the invention.

The illumination source may e.g. be a light emitting diode, LED, for emitting light based on the image content on the display device. The LED is a semiconductor device that emits incoherent narrow-spectrum light when electrically biased in the forward direction. The color of the emitted light depends on the composition and condition of the semiconducting material used, and may be near-ultraviolet, visible or infrared. By combination of several LEDs, and by varying the input current to each LED, a light spectrum ranging from near-ultraviolet to infrared wavelengths may be presented.

The present invention is not limited to what kind of illumination source that is used to create the backlighting effect. Any source capable of emitting light may be used.

In an embodiment the display device and the illumination area may be comprised in a projector that in use projects an image on an area on a surface, such as a wall. The projected image comprises a display region capable of presenting an image or image sequence to a viewer. The display region may be centered in the projected image while around it the remaining part of the projection area is utilized by a backlighting effect, comprising at least two illumination areas having different reaction speed depending on their position within the projected image. In this embodiment the outer areas may still be generated differently from the areas closer to the projected display region.

In an embodiment the illumination areas are integrated with the display device.

In other embodiments the illumination areas may be stand-alone with connectivity to the display device.

In another embodiment different backlighting settings, such as “motion enhancement” may be changed by user interaction, e.g. using the menu system of the display device when dealing with an integrated display system or using an external setup device when using a stand-alone display system. A backlighting setting may e.g. be the motion vector value threshold. By reducing this parameter the display system becomes more sensitive to motions, and accordingly this will be reflected by the light radiation emitted by the illumination areas. Another backlighting setting may refer to the size and position of the monitoring regions of the system.

In an embodiment a user interface is provided for use in conjunction with the system. The graphical user interface is configured to control user-defined or predetermined settings correlated to the monitoring regions and/or motion vectors.

The user-defined or predetermined settings may relate to a) the ideal position and size of a monitoring region, b) the default position and size of a monitoring region, c) the transformation ‘path’ between the ideal and default situation, and d) the degree to which the size of a (default) monitoring region is altered in case of camera action but no stitched image information. Also different viewing experience templates such as ‘relaxed’, ‘moderate’ or ‘action’ templates may be control using the user interface. In some embodiments the parameters in the settings a)-c) may be different for the different viewing templates. For example, for ‘relaxed’ viewing experiences the parameter-set of setting d) could be set to zero, meaning that camera action does not influence the default width, and the default sizes are all quit large, meaning that a lot of pixels are used resulting in that moving details in the picture have a relative lower influence).

In an embodiment the user interface is a graphical user interface for use in conjunction with said system to control the affected settings.

In an embodiment the user interface is integrated into a remote control having ‘on/off’ and ‘mode’ buttons allowing a user to change the settings.

In an embodiment motion vector information may be included in the image sequence for each frame. Thus instead of saving only RGB values per pixel, like current MPEG formats, also the motion vector per pixel or group of pixels is saved. Hence, according to this embodiment, the motion calculation unit may optionally not be included in the system.

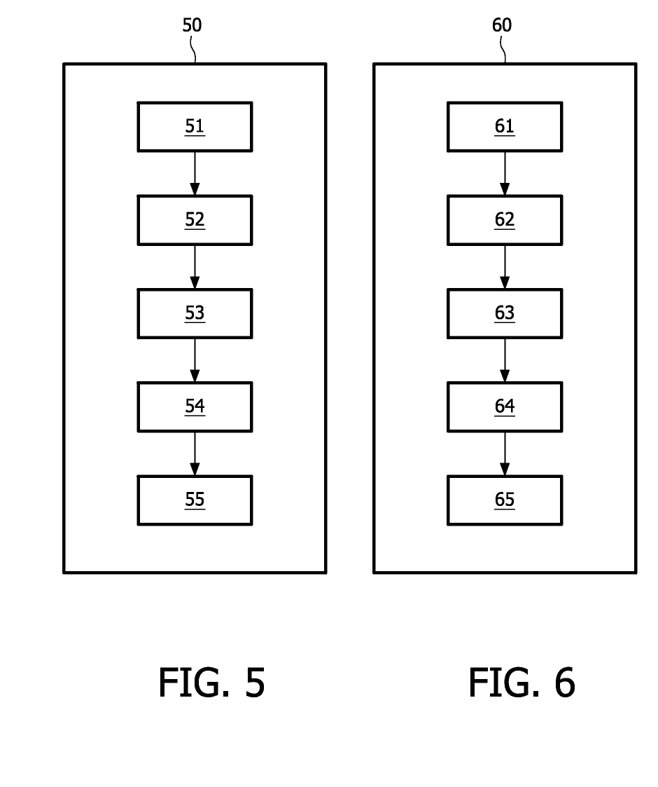

In an embodiment, according to FIG. 5, a method is provided. The method comprises adapting (52) a first image frame of an image sequence based on correlation between motion vectors of the first frame, and motion vectors of a second frame of the image sequence. The method moreover comprises reconstructing an extended image for the second frame by image stitching the adapted frame to the second frame. Furthermore, the method comprises monitoring (54) image information in at least one monitoring region comprised in the extended image, and generating a first signal, and controlling (55) light radiation emitted in use from an illumination area (16) connected to the monitoring region in response to the first signal.

In an embodiment the method further comprises calculating (51) the motion vectors of at least the first image frame and the second image frame of an image sequence.

In another embodiment a method is provided. The method comprises

calculating motion vectors of at least two subsequent frames of an image sequence. The method further comprises

adapting a previous frame of the image sequence based on the motion vectors in such way that they match the camera status of the current frame. Moreover the method comprises

reconstructing an extended image for the current frame by stitching the adapted frame to the current frame. Accordingly, the extended image will comprise the image content of the current frame together with extended image information originating from previous frames. The size of the extended image will depend on the amount of camera action, e.g. fast panning results in a larger image than slow panning, and on the number of (previous) frames being used in the adapting step. The method further comprises

generating a backlighting effect based on the extended image.

In an embodiment, according to FIG. 6, a computer-readable medium 80 is provided having embodied thereon a computer program for processing by a processor. The computer program comprises an adaptation code segment (62) configured to adapt a first image frame of an image sequence based on correlation between motion vectors of the first frame, and motion vectors of a second frame of the image sequence. The computer-readable medium may also comprise a reconstruction code segment (63) configured to reconstruct an extended image for the second frame by stitching the adapted frame to the second frame. Moreover, the computer-readable medium comprises a monitor code segment (64) configured to monitor image information in at least one monitoring region comprised in the extended image, and to generate a first signal, and a control code segment (65) configured to control light radiation emitted in use from an illumination area (16) connected to the monitoring region in response to the first signal.

In an embodiment the computer-readable medium further comprises a motion calculation code segment (61) for calculating motion vectors of at least the first image frame and the second image frame of an image sequence.

In an embodiment the computer-readable medium comprises code segments arranged, when run by an apparatus having computer-processing properties, for performing all of the method steps defined in some embodiments.

In an embodiment the computer-readable medium comprises code segments arranged, when run by an apparatus having computer-processing properties, for performing all of the display system functionalities defined in some embodiments.

Applications and use of the above-described embodiments according to the invention are various and include all cases, in which backlighting is desired.

The invention may be implemented in any suitable form including hardware, software, firmware or any combination of these. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A system (10) comprising
an adaptation unit (12) configured to adapt a first image frame of an image sequence based on correlation between motion vectors of said first frame, and motion vectors of a second frame of said image sequence,
a reconstruction unit (13) configured to reconstruct an extended image for said second frame by image stitching the adapted frame to the second frame,
a monitor unit (14) configured to monitor image information in at least one monitoring region comprised in said extended image, and to generate a first signal, and
a control unit (15) configured to control light radiation emitted in use from an illumination area (16) connected to said monitoring region in response to said first signal.

2. The system according to claim 1, wherein said control unit further is configured to control the position, or size or shape of each monitoring region comprised in the system based on the motion vectors of said first and second frame.

3. The system according to claim 1, wherein said image information is the intensity and/or color comprised in each monitoring region, and wherein said first signal comprises information regarding at least said intensity and color of each monitoring region.

4. The system according to claim 4, wherein a monitoring region corresponds to at least one or more illumination areas.

5. The system according to claim 1, further comprising a scene change detector configured to reset said extended image when a scene change is detected.

6. The system according to claim 1, wherein the control unit is further configured to control the position or size of said monitoring region depending on the extended image when said extended image comprises at least additional image information than said second frame.

7. The system according to claim 1, wherein at least one illumination area comprises a source of illumination.

8. The system according to claim 1 being comprised in a projector.

9. The system according to claim 1, further comprising a motion calculation unit (11) configured to calculate motion vectors of at least said first image frame and said second image frame of said image sequence.

10. A method comprising:
adapting a first image frame of an image sequence based on correlation between motion vectors of said first frame, and motion vectors of a second frame of said image sequence,
reconstructing an extended image for said second frame by image stitching the adapted frame to the second frame,
monitoring image information in at least one monitoring region comprised in said extended image, and generating a first signal, and
controlling light radiation emitted in use from an illumination area connected to said monitoring region in response to said first signal.

11. A computer-readable medium (60) having embodied thereon a computer program for processing by a processor, said computer program comprising:
an adaptation code segment (62) configured to adapt a first image frame of an image sequence based on correlation between motion vectors of said first frame, and motion vectors of a second frame of said image sequence,
a reconstruction code segment (63) configured to reconstruct an extended image for said second frame by stitching the adapted frame to the second frame,
a monitor code segment (64) configured to monitor image information in at least one monitoring region comprised in said extended image, and to generate a first signal, and
a control code segment (65) configured to control light radiation emitted in use from an illumination area connected to said monitoring region in response to said first signal.

12. The computer-readable medium (60) having embodied thereon a computer program for processing by a processor, said computer program comprising:
an adaptation code segment (62) configured to adapt a first image frame of an image sequence based on correlation between motion vectors of said first frame, and motion vectors of a second frame of said image sequence,
a reconstruction code segment (63) configured to reconstruct an extended image for said second frame by stitching the adapted frame to the second frame,
a monitor code segment (64) configured to monitor image information in at least one monitoring region comprised in said extended image, and to generate a first signal, and
a control code segment (65) configured to control light radiation emitted in use from an illumination area connected to said monitoring region in response to said first signal, comprising code segments arranged, when run by an apparatus having computer-processing properties, for performing all of the system functionalities defined in claim 1.

13. A user interface for use in conjunction with the system according to claim 1 configured to control user-defined or predetermined settings correlated to said monitoring region and/or motion vectors.
